(19) United States
(12) Patent Application Publication
(10) Pub. No.: US 2015/0151666 A1
(43) Pub. Date: Jun. 4, 2015

(54) Auto adjusting multiple purpose holder

(71) Applicants: Brian Stenger, Story, WY (US); Frank J. Mommsen, Sheridan, WY (US)

(72) Inventors: Brian Stenger, Story, WY (US); Frank J. Mommsen, Sheridan, WY (US)

(21) Appl. No.: 14/093,523

(22) Filed: Dec. 2, 2013

(51) Int. Cl. B60P 7/135

(52) U.S. Cl. CPC B60P 7/135

(57) ABSTRACT

A system and associated methods which may be used to adjustably secure to an all terrain or other vehicle for transporting hunting, fishing, and utility equipment, and the like are presented. In several embodiments, a system and methods involving, pivot arms, a strap acting as a movement element and an elastic stretchable strap member for compressibly securing between at least one set of biased posts disposed towards opposite ends of a support member are provided. Additionally, a system and associated methods for axially retaining a secured item are presented.

### RELATED APPLICATIONS

This invention claims the benefit of U.S. Provisional Application No. 61/735,663

### BACKGROUND OF THE INVENTION

This invention relates to a device and associated methods, which may be used to adjustably secure items to an all terrain or other vehicle for transport.

### SUMMARY OF THE INVENTION

Users of many existing gun, bow and utility holders often note a number disadvantages such as the device not securely holding the items in place, often resulting in a loose fit and wobbling effect of the equipment when transporting. Some holders may not be structurally sound and may be made of components that tend to wear easily. They may also be more complex to operate. The present invention improves and also solves these and other problems found in existing gun, bow and utility equipment holders. The present invention presents a utility gear and equipment holding system that may be attachable to an all terrain, off-road, outdoor recreational or other type of vehicles and is designed to securely hold equipment and gear such as, for example, a hunting rifle, during transport over rough, bumpy terrain. It may comprise a rigid frame or more generally a support element (that may or may not be rigid, where rigid is defined as essentially inflexible), a strap acting as a movement element or more generally a remote movement element that may be pulled or having a pulling action, and two pairs or merely only one pair of posts or more generally retaining elements that upon manipulation of the movement element, and in response thereto, compress a piece of equipment between the retaining elements. The movement element may be moved in an uncompressed direction and in a compression direction. A biasing effect may be accomplished by an elastic stretchable strap member or more generally a bias element, in conjunction with a pivot arm(s) and a strap acting as a movement element may be used to effect compression of the item to be secured. The invention may also include an axial retention element(s) such as an enlarged area of the retaining posts that may, in combination with compression, serve to prevent motion of the secured item in a direction substantially parallel to the axes of the retaining posts. The retaining posts that may compress the secured item may move closer to one another, or farther apart depending on the operation of the movement element.

### BRIEF DESCRIPTION OF THE FIGURES

FIG. 1 is an isometric top right rear view of the holder.

FIG. 2 is an isometric top right view of the holder.

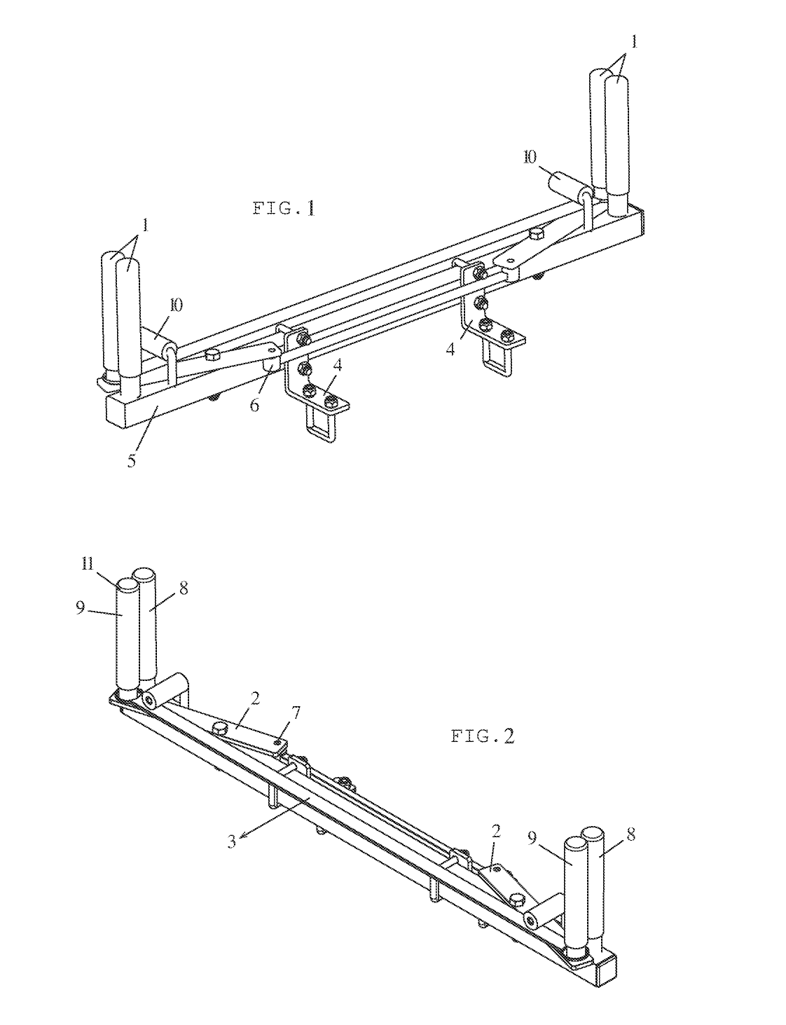

### DETAILED DESCRIPTION OF THE INVENTION

The present invention may be constructed of four posts or more generally retaining elements (1), or merely only two retaining elements, two pivot arms or merely only one pivot arm (2), a strap acting as an movement element (3), or a movement element that may be pulled, one support element or mainframe (5), and at least one elastic stretchable strap member (6), or more generally a bias element that may bias any operational retention elements (9) such as in a compression direction. The support element may be a component that would normally be attached to the vehicle or instead it may be a part of the vehicle to which the holding system is to be attached. The system is specifically adapted for use on or with an all terrain vehicle, but may also be used with or on an off-road recreational vehicle, or any other vehicles as well. The present invention may be mechanically operated by the movement element and the bias element that may be attached to each end of the pivot arm(s) by a stud or other connector (7) which goes through a hole in each end of the bias element. Two or more generally one-half of the retaining elements may be stationary or fixed (8) relative to the support element and two or more generally one-half of them operational (9), or if there are only two total retaining elements, one may be fixed and one may be operational.

The device can be operated by moving pivotally or otherwise, a movement element connected to pivot arms, which are connected to opposite ends of an elastic stretchable strap member and may be pivotally movable relative to the support element. A pivot arm(s) may be located on the end of the device or support element (or at each end of the device or support element) and may be operated by the pulling of a strap attached to said pivot arms at each end of said support element and responsive thereto. By moving (pulling action) the movement element in an uncompressed direction (i.e., one that is opposite the compression direction of movement urged by the bias element), two pivoting arms may then be moved and operational retaining elements that may be attached to the pivot arms (or that may be merely responsive to the movement of the movement element) may open (or separate from fixed retaining elements in their vicinity), allowing equipment to be easily inserted or removed between the operational retaining elements and the stationary retaining elements. When equipment is inserted it may rest securely on two rests (10) that may be located on the support element on opposite ends from each other, or merely on one rest located on the support element. The rests may not move relative to the support element and may thus be fixed. Once the equipment is in place, the movement element may be moved or relaxed in an opposite compression direction and a force may thus be applied by the bias element, resulting in a secure grip-like holding of the equipment. Over at least a portion of the movement, all points on the operational retention element(s) may move towards the fixed retention element(s) for substantially equal distances such that there is no rotation of the operational posts during their movement. Compression, as used herein and in the claims, is defined as pressurization, with or without direct contact between the item pressurized and object creating the pressure. All movement of the movement element may occur in a substantially horizontal plane, where this horizontal plane is defined as a plane that is parallel to that plane defined by the points of contact of the wheels of the vehicle with the ground. The invention may also include an axial retention element(s) such as an enlarged area of the retaining posts (11) that may, in combination with compression, serve to prevent motion of the secured item in a direction substantially parallel to the axes of the retaining posts. Attachment components (4) may secure the assembly to a vehicle, an off-road recreational vehicle, or more specifically, an all terrain vehicle and may include several different types of components.

The present invention may be made up of steel, rubber or be injection molded. Any posts or retaining elements may be made of piping with a rubber tubing as a sleeve, or more generally a yieldable protective material or element over the piping to protect the item and enhance retention by yieldably engaging it. Any rests may be made of a round stock with a rubber tubing as a sleeve covering the stock. The mainframe or support element may be constructed of square tubing and may have two plastic end plugs in each end of the support element. The support element may also have attached a relatively small post welded at each end to create a right angle and the two rests may be welded parallel to the post. Each pivot arm may consist of flat steel plates and piping with a rubber sleeve to act as a grip. The strap used as a movement element can be made of nylon webbing and having a steel o-ring at each end. All post or retaining element tops may be enlarged to provide further axial or vertical retention of the secured element. All components may be painted to help reduce exposure to the elements. There may also be included attachment components such as, for example, nuts and U-bolts and elbow joints that maybe used to attach the entire assembly to an all terrain or other vehicle. What might be significant in one preferred embodiment may include, but not be limited to the following elements:

To provide extremely quick removal and insertion of equipment in that the user does not have to undo any Velcro™ or rubber straps as may be seen in existing products.

To provide rigid holding capabilities with no wobbling effect of the equipment.

To provide an adjustable feature which allows for different sizes of equipment to be securely attached and transported without possible damage due to a loose fit.

To provide a sporting and utility equipment holder with greater capabilities than existing holders and to be able to manufacture the holder at a competitive price.

To provide quick accessibility to the equipment from a vehicle.

As can be easily understood from the foregoing, the basic concepts of the present invention may be embodied in a variety of ways. It involves both holding methods as well as devices to accomplish the appropriate holding. In this application, the holding methods are disclosed as part of the results shown to be achieved by the various devices described and as steps, which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention is described in device-oriented terminology, each element of the device implicitly performs a function. Apparatus claims may not only be included for the device described, but also method or process claims may be included to address the functions the invention and each element performs. Neither the description nor the terminology is intended to limit the scope of the claims in this application.

It should also be understood that a variety of changes may be made without departing from the essence of the invention. Such changes are also implicitly included in the description. They still fall within the scope of this invention. A broad disclosure encompassing both the explicit embodiment(s) shown, the great variety of implicit alternative embodiments, and the broad methods or processes and the like are encompassed by this disclosure and may be relied upon for support for the claims in this application.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element, which causes that action. Similarly, each physical element disclosed should be understood to encompass a disclosure of the action, which that physical element facilitates. Regarding this last aspect, as but one example, the disclosure of a “holder” should be understood to encompass disclosure of the act of “holding” whether explicitly discussed or not and, conversely, were there effectively disclosure of the act of “holding”, such a disclosure should be understood to encompass disclosure of a “holder” and even a “means for holding” Such changes and alternative terms are to be understood to be explicitly included in the description.

Any acts of law, statutes, regulations, or rules mentioned in this application for patent; or patents, publications, or other references mentioned in this application for patent are hereby incorporated by reference. In addition, as to each term used it should be understood that unless its utilization in this application is inconsistent with such interpretation, common dictionary definitions should be under stood as incorporated for each term and all definitions, alternative terms, and synonyms such as contained in the Random House Webster's Unabridged Dictionary, second edition are hereby incorporated by reference. Finally, all references listed in the list of references or other information statement filed with the application are hereby appended and hereby incorporated by reference, however, as to each of the above, to the extent that such information or statements incorporated by reference might be considered inconsistent with the patenting of this/these invention(s) such statements are expressly not to be considered as made by the applicant(s).

Thus, the applicant(s) should be understood to have support to claim at least: i) each of the holding devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described herein before and with reference to any of the accompanying examples, x) the various combinations and permutations of each of the elements disclosed, xi) each potentially dependent claim or concept as a dependency on each and every one of the independent claims or concepts presented. In this regard it should be understood that for practical reasons and so as to avoid adding potentially hundreds of claims, the applicant may eventually present claims with initial dependencies only. Support should be understood to exist to the degree required under new matter laws-including but not limited to United States Patent Law 35 USC 132 or other such laws—to permit the addition of any of the various dependencies or other elements presented under one independent claim or concept as dependencies or elements under any other independent claim or concept. Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible.

1. A method for securing an item to an outdoor recreational vehicle, comprising the steps of: a. establishing a support element on said vehicle; b. establishing at least one fixed retention element fixed relative to said support element; c. biasing at least one operational retention element in a compression direction; d. moving a movement element in a first operational direction; e. remotely moving said at least one operational retention element in an uncompressed direction in response to said step of moving said movement element in said first operational direction; f. positioning said item between said at least one fixed retention element fixed relative to said support element and said at least one operational retention element; g. relaxing said movement element in a second operational direction opposite said first operational direction; h. remotely moving said at least one operational retention element in a compression direction in response to said step of operational direction relaxing said movement element in said second operational direction; i. compressibly retaining said item between said fixed retention element and said operational retention element.

2. A method for securing an item to an outdoor recreational vehicle as in claim 1, wherein said step of remotely moving said at least one operational retention element in a compression direction further comprises the step of substantially equally moving all points along said operational retention element towards said fixed retention element.

3. A method for securing an item to an outdoor recreational vehicle as in claim 1 and further comprising the step of moving a strap acting as a movement element in response to said step of moving a movement element in a first operational direction.

4. A method for securing an item to an outdoor recreational vehicle as in claim 1 wherein said step of moving a movement element in a first operational direction comprises the step of a pulling action moving said operational retention elements.

5. A method for securing an item to an outdoor recreational vehicle as in claim 1 wherein said step of positioning said item between said at least one fixed retention element fixed relative to said support element and said at least one operational retention element comprises the step of placing said item on at least one fixed support rest fixed relative to said support member.

6. A method for securing an item to an outdoor recreational vehicle as in claim 1 and further comprising the step of axially retaining said item to be secured.

7. A method for securing an item to an outdoor recreational vehicle as in claim 1 wherein said step of biasing comprises the step of an elastic stretchable strap member said at least one operational retention element.

8. A method for securing an item to an outdoor recreational vehicle as in claim 1 wherein said step of establishing a support element on said vehicle comprises the step of attaching said support element to said vehicle.

9. A method for securing an item to an outdoor recreational vehicle as in claim 1 wherein said step of compressibly retaining said item comprises the step of yieldably retaining said item through direct contact between said item and at least one retention element.

10. A method for securing an item to an outdoor recreational vehicle as in claim 4 and further comprising the step of moving at least one pivot arm in response to said step of moving a movement element in a first operational direction.

11. A method for securing an item to an outdoor recreational vehicle as in claim 1 wherein said step of remotely moving said at least one operational retention element in an uncompressed direction comprises the step of remotely moving at least two operational retention elements in an uncompressed direction.

12. A method for securing an item to an outdoor recreational vehicle as in claim 10 and further comprising the steps of: a. substantially equally moving all points along said operational retention elements towards said fixed retention elements; b. placing said item on at least one fixed support rest fixed relative to said support member.

13. A system for securing an item to an outdoor recreational vehicle, comprising: a. a support element; b. at least one fixed retention element fixed relative to said support element; c. a remote movement element action movable relative to said support element; d. at least one operational retention element responsive to said remote movement element; e. a bias element to which said operational retention element is responsive.

14. A system for securing an item to an outdoor recreational vehicle as in claim 4 wherein said remote movement element is connected to said operational retention elements at a point that is located at each end of support element.

15. A system for securing an item to an outdoor recreational vehicle as in claim 13, wherein said at least one fixed retention element is attached to said support element at substantially the end of said support element.

16. A system for securing an item to an outdoor recreational vehicle as in claim 14, wherein said strap acting as a movement element has an attachment element at each end.

17. A system for securing an item to an outdoor recreational vehicle as in claim 13 further comprising at least one fixed rest fixed relative to said support element.

18. A system for securing an item to an outdoor recreational vehicle as in claim 13 wherein said bias element is an elastic stretchable strap member.

19. A system for securing an item to an outdoor recreational vehicle as in claim 13 wherein said at least one fixed retention element and said at least one operational retention element comprise a yieldable protective element.

20. A system for securing an item to an outdoor recreational vehicle as in claim 13 further comprising at least one pivot arm pivotally movable relative to said support element.

21. A system for securing an item to an outdoor recreational vehicle as in claim 18 wherein said at least one operational retention element responsive to said remote movement element comprises two operational retention elements.

22. A system for securing an item to an outdoor recreational vehicle, comprising: a. a support element; b. a singularly controllable remote movement element movable relative to said support element; c. two fixed retention elements fixed relative to said support element; d. two operational retention elements responsive to said singularly controllable remote movement element in an uncompressed direction; e. a linked motion mechanism connected to said two operational retention elements and said singularly controllable remote movement element; f. at least one bias element to which said two operational retention elements are responsive in a compressive direction that is opposite said uncompressed direction.
